(19) United States
(12) Patent Application Publication
(10) Pub. No.: US 2015/0044487 A1
(43) Pub. Date: Feb. 12, 2015

(54) ORIENTED-FILM-FORMING COMPOSITION

(71) Applicant: SUMITOMO CHEMICAL COMPANY, LIMITED, Tokyo (JP)

(72) Inventor: Tadahiro KOBAYASHI, Osaka-shi (JP)

(73) Assignee: SUMITOMO CHEMICAL COMPANY, LIMITED, Tokyo (JP)

(21) Appl. No.: 14/454,347

(22) Filed: Aug. 7, 2014

(30) Foreign Application Priority Data
Aug. 9, 2013 (JP) 2013-165941

(51) Int. Cl. G02B 5/30; C09D 179/08; C09K 19/38; G02F 1/13363; B05D 3/00; B05D 3/06; G02B 1/12; C08K 5/13; B05D 1/00

(52) U.S. Cl. CPC G02B 5/3083; C08K 5/13; C09D 179/08; C09K 19/3809; B05D 1/00; B05D 3/007; B05D 3/06; G02B 1/12; G02F 1/13363; G02F 2001/133638
USPC 428/473.5; 428/523; 428/476.9; 524/104; 427/393.5; 427/553

(57) ABSTRACT

Provided is an oriented-film-forming composition that can give a laminated body which has a substrate, an oriented film and an optically anisotropic film and which is excellent in heat resistance and light resistance. The oriented-film-forming composition is a composition including an oriented-film-forming material and an antioxidant. The antioxidant is preferably a phenolic antioxidant. The oriented-film-forming material preferably contains at least one selected from the group consisting of polyimides, polyamides and polyamic acids. The composition preferably satisfies Mw(A)/Mw(B)>0.85 wherein Mw(B) represents the weight-average molecular weight of the oriented-film-forming material after the composition is heated at 100° C. for 1 hour, and Mw(A) represents that of the same material before the heating.

### BACKGROUND OF THE INVENTION

1. Field of the Invention

The present invention relates to an oriented-film-forming composition.

2. Description of the Related Art

A flat panel display device includes an optically anisotropic film such as a polarizing plate or a retardation plate. The optically anisotropic film is produced by applying a composition containing a polymerizable liquid crystal compound onto an oriented-film-formed substrate to yield a coat film, and then polymerizing the polymerizable liquid crystal compound in the coat film.

Japanese unexamined patent publication JP-A-2013-57803 describes, as an oriented-film-forming composition, which is for forming an oriented film, a composition containing an oriented-film-forming material and a solvent.

Oriented-film-forming compositions of the related art do not necessarily give a satisfactory heat resistance or light resistance to a laminated body having a substrate, an oriented film obtained from any one of the compositions, and an optically anisotropic film.

### SUMMARY OF THE INVENTION

The present invention for solving the problem is as follows:

[1] An oriented-film-forming composition, comprising an oriented-film-forming material and an antioxidant.

[2] The composition according to item [1], wherein the antioxidant is a phenolic antioxidant.

[3] The composition according to item [1] or [2], wherein the oriented-film-forming material comprises at least one selected from the group consisting of polyimides, polyamides and polyamic acids.

[4] The composition according to any one of items [1] to [3] which satisfies Mw(A)/Mw(B)>0.85 wherein Mw(B) represents the weight-average molecular weight of the oriented-film-forming material after the composition is heated at 100° C. for 1 hour, and Mw(A) represents the weight-average molecular weight of the oriented-film-forming material before the heating.

[5] The composition according to any one of items [1] to [4], wherein the oriented-film-forming material has an orientation regulating force for causing a polymerizable liquid crystal compound to be vertically oriented.

[6] An oriented-film-attached resin substrate, comprising a resin substrate, and an oriented film formed over a surface of the resin substrate and comprising the composition recited in any one of items [1] to [5].

[7] The oriented-film-attached resin substrate according to item [6], wherein the resin substrate comprises a polyolefin.

[8] A method for producing an oriented-film-attached resin substrate, comprising: applying the composition recited in any one of items [1] to [5] to a resin substrate, and drying the resultant.

[9] A laminated body, comprising the oriented-film-attached resin substrate recited in item [6] or [7], and an optically anisotropic film to arrange the resin substrate and the oriented film of the substrate, and the optically anisotropic film in this three-member-described order.

[10] The laminated body according to item [9], wherein the optically anisotropic film is a retardation film.

[11] The laminated body according to item [9] or [10], which is used for an in-plane switching (IPS) liquid crystal display device.

[12] A method for producing a laminated body comprising a resin substrate, an oriented film, and an optically anisotropic film in the order that the three members are described herein,
comprising: applying the composition recited in any one of items [1] to [5] to the resin substrate, thereby yielding an oriented-film-attached resin substrate; further applying a composition comprising a polymerizable liquid crystal compound and a photopolymerization initiator to the outer surface of the oriented film of the oriented-film-attached resin substrate; and radiating light to the resultant laminated body.

[13] A polarizing plate, comprising the laminated body recited in any one of items [9] to [11].

[14] A display device, comprising the laminated body recited in any one of items [9] to [11].

According to the oriented-film-forming composition of the present invention, a laminated body can be obtained which has a substrate, an oriented film, and an optically anisotropic film to be excellent in heat resistance and light resistance.

### BRIEF DESCRIPTION OF THE DRAWINGS

FIGS. 1A to 1E are each a schematic view illustrating an example of the polarizing plate according to the present invention; and

FIGS. 2A and 2B are each a schematic view illustrating an example of the display device according to the invention.

### DETAILED DESCRIPTION OF THE PREFERRED EMBODIMENTS

### <Oriented-Film-Forming Composition>

### [Oriented-Film-Forming Material]

Examples of the oriented-film-forming material include orienting polymers and optically orienting polymers. Preferred are orienting polymers.

The oriented-film-forming material preferably has such a solvent resistance that the material is not dissolved in a solvent used when a composition containing a liquid crystal compound that will be detailed later is applied or painted, and a heat resistance against heating treatment for removing an organic solvent and adjusting the orientation of the liquid crystal compound.

Examples of the orienting polymer include polyamides and gelatins, which each have in the molecule thereof amide bonds, polyimides, which each have in the molecule thereof imide bonds, polyamic acids, which are each a hydrolyzate of a polyimide, polyvinyl alcohol, alkyl-modified polyvinyl alcohol, polyacrylamide, polyoxazole, polyethyleneimine, polystyrene, polyvinyl pyrrolidone, polyacrylic acid, and polyacrylates. Of these examples, preferred is at least one selected from the group consisting of polyamides, polyimides, and polyamic acids. Such orienting polymers may be used alone, or in the form of a composition or copolymer made of any combination of two or more thereof. The orienting polymer can easily be obtained by subjecting a monomer thereof to a polycondensation based on dehydration or dealcoholization, a chain polymerization such as radical polymerization, anion polymerization or cation polymerization, coordination polymerization, ring-opening polymerization or some other polymerization.

Examples of a commercially available product of the orienting polymer include products Sunever ((registered trademark) manufactured by Nissan Chemical Industries, Ltd.), and Optmer ((registered trademark) manufactured by JSR Corporation).

An oriented film formed by use of the orienting polymer makes the liquid crystal orientation of a polymerizable liquid crystal compound easy. In accordance with the kind of the orienting polymer or rubbing conditions therefor, the liquid crystal can be controlled into various orientations such as horizontal orientation, vertical orientation, hybrid orientation and oblique orientation. The oriented film is usable for an improvement in the visual field angle of various liquid crystal panels.

The optically orienting polymer may be a polymer having a photosensitive structure. When polarized light is radiated onto the polymer having a photosensitive structure, the photosensitive structure in the light-radiated region is isomerized or crosslinked so that the optically orienting polymer is oriented. As a result, orientation regulating force is given to a film made of the optically orienting polymer. Examples of the photosensitive structure include azobenzene, maleimide, chalcone, cinnamic acid, 1,2-vinylene, 1,2-acetylene, spiropyran, spirobenzopyran, and fulgide structures. Such optically orienting polymers may be used alone, in the form of a combination of two or more thereof, or in the form of a copolymer having different photosensitive structures. The optically orienting polymer can be obtained by subjecting a monomer having a photosensitive structure to polycondensation based on dehydration or dealcoholization, a chain polymerization such as radical polymerization, anion polymerization or cation polymerization, coordination polymerization, ring-opening polymerization or some other polymerization. Examples of the optically orienting polymer include optically orienting polymers described in Japanese Patent Nos. 4450261, 4011652 and 4404090, and Japanese unexamined patent publications JP-A-2010-49230, JP-A-2007-156439 and JP-A-2007-232934. Of these examples, preferred are polymers that can each form a crosslinked structure by irradiation with polarized light from the viewpoint of the endurance thereof.

### [Antioxidant]

Examples of the antioxidant include phenolic antioxidants, sulfur-containing antioxidants, and amine compounds. Preferred are phenolic antioxidants, about which no problem is caused about the coloration of respective oxidized products produced from the antioxidants.

Examples of the phenolic antioxidants include 2,6-bis(1,1-dimethylethyl)-4-methylphenol, 2-tert-butyl-6-(3-tert-butyl-2-hydroxybenzyl)-4-methylpheny 1 acrylate (SUMILIZER (registered trademark) GM), 2-[1-(2-hydroxy-3,5-di-tert-pentylphenyl)ethyl]-4,6-di-tert-pentylphenyl acrylate (SUMILIZER (registered trademark) GS(F)),

6-[3-(3-tert-butyl-4-hydroxy-5-methylphenyl)propoxy]-2,4,8,10-tetra-tert-butyl-dibenzo[d,f] [1,3,2]dioxaphosphepin (SUMILIZER (registered trademark) GP),

3,9-bis[2-[3-(3-tert-butyl-4-hydroxy-5-methylphenyl)propionyloxy]-1,1-dimehylethyl]-2,4,8,10-tetraoxaspiro[5.5]undecane (SUMILIZER (registered trademark) GA-80), and 4,4′-thiobis(6-tert-butyl-3-methylphenol) (SUMILIZER (registered trademark) WX-R) (all of them are manufactured by Sumitomo Chemical Co., Ltd.); and antioxidants Irganox (registered trademark) 1010, 1035, 1076, 1098, 1135, 1330, 1726, 1425WL, 1520L, 245, 259, 3114, 565, and 295 (all of them are manufactured by Ciba Japan K.K.).

The content of the antioxidant in the oriented-film-forming material is usually from 0.001 to 10 parts by mass, preferably from 0.01 to 5 parts by mass for 100 parts by mass of the material. When the content is in the range, the antioxidant is not to disturb the orientation of the polymerizable liquid crystal compound in a subsequent step, and further the antioxidant can keep an excellent stability of the oriented-film-forming composition.

### [Solvent]

The oriented-film-forming composition may contain a solvent. Examples of the solvent include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, methyl isobutyl ketone, and N-methyl-2-pyrrolidone; aliphatic hydrocarbon solvents such as pentane, hexane and heptane; aromatic hydrocarbon solvents such as toluene, xylene and chlorobenzene; nitrile solvents such as acetonitrile; ether solvents such as propylene glycol monomethyl ether, tetrahydrofuran, and dimethoxyethane; and halogenated hydrocarbon solvents such as chloroform. These solvents may be used alone or in combination.

The content of the solvent in the oriented-film-forming material is preferably from 10 to 100000 parts by mass, more preferably from 1000 to 50000 parts by mass, even more preferably from 2000 to 20000 parts by mass for 100 parts by mass of the material.

The oriented-film-forming composition of the present invention preferably satisfies Mw(A)/Mw(B)>0.85 wherein Mw(B) represents the weight-average molecular weight of the oriented-film-forming material after the composition is heated at 100° C. for 1 hour, and Mw(A) represents the weight-average molecular weight of the oriented-film-forming material before the heating.

The weight-average molecular weight is measurable by use of a commercially available gel permeation chromatograph (GPC). When attention is paid to a polymer component of the oriented-film-forming material, the molecular weight Mw is an index representing the proportion of the polymer component to the whole of the material. A matter that the ratio Mw(A)/Mw(B) becomes less than 1 denotes that the proportion of the polymer component in the oriented-film-forming composition increases after the composition is heated. The oriented-film-forming composition of the present invention preferably satisfies the inequality, so that the generation of the polymer component is restrained even after the heating, and further the composition also has stability in a subsequent step which will be detailed later.

### <Oriented-Film-Attached Resin Substrate>

The oriented-film-attached resin substrate of the present invention has, over a surface of its resin substrate, an oriented film formed from the oriented-film-forming composition of the invention. In the oriented-film-attached resin substrate of the invention, the oriented film is not easily peeled from the resin substrate by friction when the oriented-film-attached resin substrate is transported, and by other causes.

The resin substrate is usually a translucent resin substrate. The translucent resin substrate means a resin substrate having such a translucency that the substrate can transmit light, in particular, visible rays. Translucency denotes a property of that the transmittance of any object or member for light rays having wavelengths from 380 to 780 nm is 80% or more. The resin substrate may be usually a substrate in the form of a film.

Examples of the resin that constitutes the translucent resin substrate include polyolefins such as polyethylene, polypropylene, cycloolefin polymers, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylene sulfides; and polyphenylene oxides. Preferred are polyolefins such as polyethylene, polypropylene and norbornene-based polymers, polyethylene terephthalate, and polymethacrylates. More preferred are such polyolefins.

Before the oriented film is formed onto the resin substrate, the resin substrate may be subjected to surface treatment. Examples of the method for the surface treatment include a method of treating a surface of the resin substrate with corona or plasma in a vacuum or in the atmosphere; a method of treating a surface of the resin substrate with a laser; a method of treating a surface of the resin substrate with ozone; a method of subjecting a surface of the resin substrate to saponifying treatment or flame treatment; a method of painting a coupling agent onto a surface of the resin substrate to conduct primer treatment; and a graft polymerization method of causing a reactive monomer or a polymer having reactivity to adhere onto a surface of the resin substrate, and then radiating radial rays, plasma or ultraviolet rays thereto to cause a reaction of the monomer or polymer. Of these examples, preferred is the method of treating a surface of the resin substrate with corona or plasma in a vacuum or in the atmosphere.

The method of treating a surface of the resin substrate with corona or plasma is, for example,
a method i) of setting the resin substrate between opposed electrodes under a pressure close to the atmospheric pressure, and then generating corona or plasma to treat the surface of the resin substrate therewith,
a method ii) of causing a gas to flow into the gap between opposed electrodes, making the gas into plasma between the electrodes, and blowing the plasma-state gas onto the surface of the resin substrate; or
a method iii) of generating glow discharge plasma under a low pressure to treat the surface of the resin substrate therewith.

Of these methods, preferred are the methods i) and ii). Usually, these surface treatments with corona or plasma can be conducted in a commercially available surface treatment apparatus.

Examples of the method for producing the oriented-film-attached resin substrate include a method A) of applying the oriented-film-forming composition to the resin substrate, and drying the resultant; a method B) of applying the oriented-film-forming composition to the resin substrate, drying the resultant, and rubbing the outer surface of the applied composition; and a method C) of applying the oriented-film-forming composition to the resin substrate, drying the resultant, and radiating polarized light onto the dried product.

Of these methods, preferred are the methods A) and B) from the viewpoint of the evenness of the liquid crystal orientation of the liquid crystal compound formed on the oriented film, and the period and costs for the production.

By the drying, the solvent and other low-boiling-point components are removed.

Examples of the method for applying the oriented-film-forming composition to the resin substrate include extrusion coating, direct gravure coating, reverse gravure coating, CAP coating, die coating, and slit coating methods; and a method of attaining the application, using a coater such as a dip coater, a bar coater, or a spin coater. Of these methods, preferred are die coating, gravure coating and slit coating methods since these methods make it possible to attain a continuous production of the oriented-film-attached resin substrate in a roll-to-roll manner, and make an improvement in the evenness of the resultant coat.

Examples of the method for the drying include natural drying, ventilation drying, heat drying, and reduced-pressure drying; and any combination of two or more of these methods. The drying temperature is preferably from 10 to 250° C., more preferably from 25 to 200° C. The drying period, which depends on the kind of the solvent, is preferably from 5 seconds to 60 minutes, more preferably from 10 seconds to 30 minutes.

Only by applying and drying the oriented-film-forming material, some species of the material may exhibit a property of causing a liquid crystal compound to be liquid-crystal-oriented (hereinafter the property may be referred to as orientation regulating force) in accordance with the kind thereof. Other species of the oriented-film-forming material may exhibit orientation regulating force by further rubbing the material or radiating polarized light to the material.

The method for the rubbing may be a method of bringing a rubbing-cloth-wound rubbing roll that is being rotated into contact with a coat formed by applying the oriented-film-forming composition to the resin substrate and then drying the resultant (hereinafter such a coat may be referred to as a dried coat).

In the case of a dried coat formed from the optically orienting polymer, polarized light is usually radiated onto the polymer. The optically orienting polymer is preferably a polymer that forms a crosslinked structure by irradiation with light from the viewpoint of the endurance of the resultant oriented film.

The method for radiating the polarized light is, for example, a method by use of a device described in JP-A-2006-323060. A patterned oriented film can be formed by radiating polarized light, such as linearly polarized ultraviolet rays, onto a desired region (composed of plural sections) through a photomask corresponding to the desired region, and repeating this operation also for each of other desired regions. Generally, the photomask may be a member in which a light-shielding pattern is located onto a piece or film made of quartz, soda-lime glass, polyester or some other material. The region covered with the light-shielding pattern shuts out the radiated polarized light while the region uncovered therewith transmits the polarized light. The quartz glass piece is preferred since the effect of thermal expansion to the piece is small. The radiated polarized light is preferably ultraviolet rays from the viewpoint of the reactivity of the optically orienting polymer with the rays.

The thickness of the oriented film formed over the oriented-film-attached resin substrate is usually from 10 to 10000 nm, preferably from 10 to 1000 nm. When the thickness of the oriented film is in the range, a liquid crystal compound can be favorably oriented into a desired direction or angle on the oriented film.

The oriented-film-attached resin substrate is useful as a substrate for forming an optically anisotropic film such as a retardation film or a polarization film, and is also useful as a member for a polarizing plate or circularly polarizing plate that includes such an optically anisotropic film. The oriented-film-attached resin substrate is useful, in particular, as a substrate of a retardation film.

### <Optically Anisotropic Film>

A retardation film can be obtained by orienting a liquid crystal compound vertically or horizontally onto the surface of the oriented film of the oriented-film-attached resin substrate. In the present invention, such a wording as “vertical orientation” (of a liquid crystal compound) denotes that the liquid crystal compound has a long axis thereof vertically to the plane of the resin substrate. Such a wording as “horizontal orientation” thereof denotes that the liquid crystal compound has a long axis thereof in parallel with the plane of the resin substrate.

The liquid crystal compound is preferably a polymerizable liquid crystal compound. The polymerizable liquid crystal compound is a liquid crystal compound having a polymerizable group. Usually, the polymerizable liquid crystal compound forms an optically anisotropic film by liquid-crystal-orienting the compound on the outer surface of the oriented film and then polymerizing the compound.

The liquid crystal orientation of the liquid crystal compound is controlled by respective properties of the oriented film and the liquid crystal compound. For attaining vertical orientation, it is preferred to select a liquid crystal compound that is vertically oriented with ease, and an oriented film that easily causes this liquid crystal compound to be vertically oriented.

When the oriented film is made of, for example, a material expressing, as orientation regulating force, horizontal orientation regulating force, the liquid crystal compound can attain horizontal orientation or hybrid orientation. When the oriented film is made of a material expressing vertical orientation regulating force, the liquid crystal compound can attain vertical orientation or oblique orientation.

When the oriented film is made of an orienting polymer, the orientation regulating force is adjustable at will in accordance with the outer surface state or rubbing conditions. When the oriented film is made of an optically orienting polymer, the force is adjustable at will in accordance with polarized-light-radiating conditions and others. The liquid crystal orientation is also controllable by selecting the surface tension, the liquid crystal property or some other property of the polymerizable liquid crystal compound.

For the formation of an optically anisotropic film in which a liquid crystal compound is liquid-crystal-oriented, a composition containing the liquid crystal compound (referred to also as the optically-anisotropic-layer-forming composition hereinafter) is usually used. This composition may contain two or more liquid crystal compounds.

The above-mentioned polymerizable liquid crystal compound is, for example, a compound containing a group represented by the following formula (X) (the compound may be referred to as the compound (X) hereinafter):

P¹¹—B¹¹—E¹¹—B¹²—A¹¹—B¹³— (X)

wherein: P¹¹ represents a polymerizable group;

A¹¹ represents a bivalent alicyclic hydrocarbon group or bivalent aromatic hydrocarbon group provided that any hydrogen atom contained in the bivalent alicyclic hydrocarbon group or bivalent aromatic hydrocarbon group may be substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms may be substituted with a fluorine atom;
B¹¹ represents —O—, —S—, —CO—O—, —O—CO—, —O—CO—, —CO—NR¹⁶—, —NR¹⁶—CO—, —CO—, —CS— or a single bond wherein R¹⁶s each represent a hydrogen atom or an alkyl group having 1 to 6 carbon atoms (the same applies to the following R¹⁶s);
B¹² and B¹³ each independently represent —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond; and

E¹¹ represents an alkanediyl group having 1 to 12 carbon atoms provided that any hydrogen atom contained in the alkanediyl group maybe substituted with an alkoxy group having 1 to 5 carbon atoms provided that any hydrogen atom contained in the alkoxy group may be substituted with a halogen atom, and provided that any —CH₂— that constitutes the alkanediyl group maybe replaced with —O— or —CO—.

The number of the carbon atoms of the aromatic hydrocarbon group or alicyclic hydrocarbon group as A¹¹ is preferably from 3 to 18, more preferably from 5 to 12, in particular preferably 5 or 6. A¹¹ is preferably a cyclohexane-1,4-diyl group, or 1,4-phenylene group.

E¹¹ is preferably a linear alkanediyl group having 1 to 12 carbon atoms. Any —CH₂— that constitutes the alkanediyl group may be replaced with —O—.

Specific examples of the group include linear alkanediyl groups having 1 to 12 carbon atoms, such as methylene, ethylene, propane1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; and —CH₂—CH₂—O—CH₂—CH₂—, —CH₂—CH₂—O—CH₂—CH₂—O—CH₂—CH₂—, and —CH₂—CH₂—O—CH₂—CH₂—O—CH₂—CH₂—O—CH₂—C₂—.

B¹¹ is preferably 'O—, —S—, —CO—O—, or —O—CO—, more preferably —CO—O—.

B¹² and B¹³ are each independently preferably —O—, —S—, —C(═O)—, —C(═O)—O—, —O—C(═O)—, or —O—C(═O)—O—, more preferably —O—, or —O—C(═O)—O—.

The polymerizable group represented by P¹¹ is preferably a radical polymerizable group or cation polymerizable groups since the group is high in polymerization reactivity, in particular, photopolymerization reactivity. The polymerizable group is preferably a group represented by any one of the following formulae (P-11) to (P-15) since the group is easy to handle, and the production itself of the liquid crystal compound is also easy:

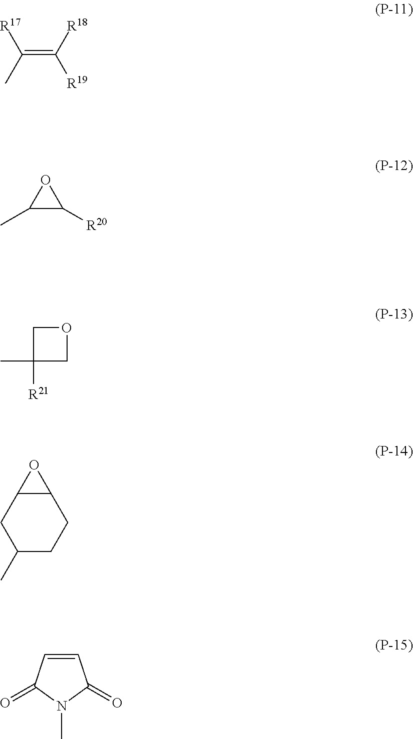

wherein R¹⁷ to R²¹ in the formulae (P-11) to (P-13) each independently represent an alkyl group having 1 to 6 carbon atoms, or a hydrogen atom.

Specific examples of the group represented by any one of the formulae (P-11) to (P-15) include respective groups represented by the following formulae (P-16) to (P-20):

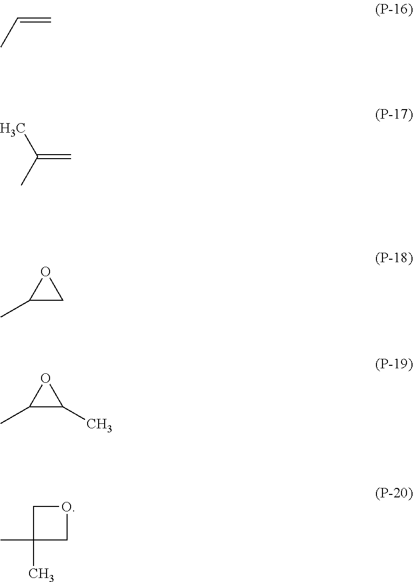

P¹¹ is preferably a group represented by any one of the formulae (P-14) to (P-20), more preferably a vinyl, p-stilbene, epoxy or oxetanyl group.

More preferably, the group represented by P¹¹—B¹¹— is an acryloyloxy or methacryloyloxy group.

Examples of the compound (X) include respective compounds represented by the following formulae (I), (II), (III), (IV), (V) and (VI):

P¹¹—B¹¹-E¹¹-B¹²-A¹¹-B¹³-A¹²-B¹⁴-A¹³-B¹⁵-A¹⁴-B¹⁶-E¹²-B¹⁷—P¹² (I),

P¹¹—B¹¹-E¹¹-B¹²-A¹¹-B¹³-A¹²-B¹⁴-A¹³-B¹⁵-A¹⁴-E¹¹ (II),

P¹¹—B¹¹-E¹¹-B¹²-A¹¹-B¹³-A¹²-B¹⁴-A¹³-B¹⁵-E¹²-B¹⁷—P¹² (III),

P¹¹—B¹¹-E¹¹-B¹²-A¹¹-B¹³-A¹²-B¹⁴-A¹³F¹¹ (IV),

P¹¹—B¹¹-E¹¹-B¹²-A¹¹-B¹³-A¹²-B¹⁴-E¹²-B¹⁷—P¹² (V), and

P¹¹—B¹¹-E¹¹-B¹²-A¹¹-B¹³-A¹²-F¹¹ (VI)

wherein A¹² to A¹⁴ each independently have the same meaning as A¹¹; B¹⁴ to B¹⁵ each independently have the same meaning as B¹²; B¹⁷ has the same meaning as B¹¹; E¹² has the same meaning as E¹¹; and

F¹¹ represents a hydrogen or halogen atom, or an alkyl group having 1 to 13 carbon atoms, an alkoxy group having 1 to 13 carbon atoms, a cyano, nitro, trifluoromethyl, dimethylamino, hydroxyl, methylol, formyl, sulfo (—SO₃H) or carboxyl group, or an alkoxycarbonyl group having 1 to 10 carbon atoms provided that any —CH₂— that constitutes the alkyl or alkoxy group may be replaced with —O—.

Specific examples of the polymerizable liquid crystal compound include compounds each having a polymerizable group out of compounds described, in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); and polymerizable liquid crystal compounds described in JP-A-2010-31223, JP-A-2010-270108, JP-A-2011-6360, and JP-A-2011-207765.

Specific examples of the compound (X) include respective compounds represented by formulae (I-1) to (I-4 ), formulae (II-1) to (II-4), formulae (III-1) to (III-26), formulae (IV-1) to (IV-26), formulae (V-1) to (V-2), and formulae (VI-1) to (VI-6) illustrated below. In these formulae, k1s and k2s each independently represent an integer of 2 to 12. These compounds (X) are preferred since they can easily be synthesized or are easily available.

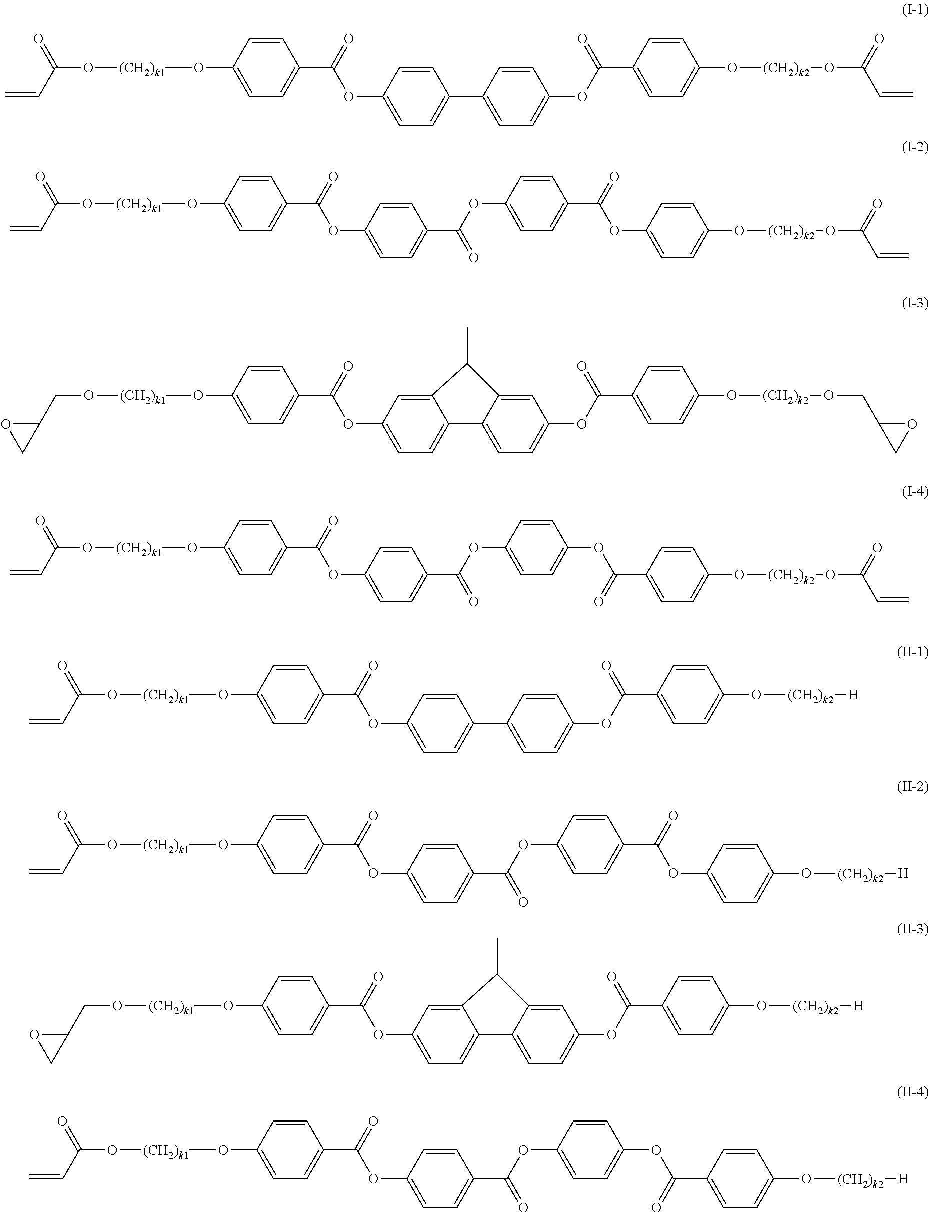

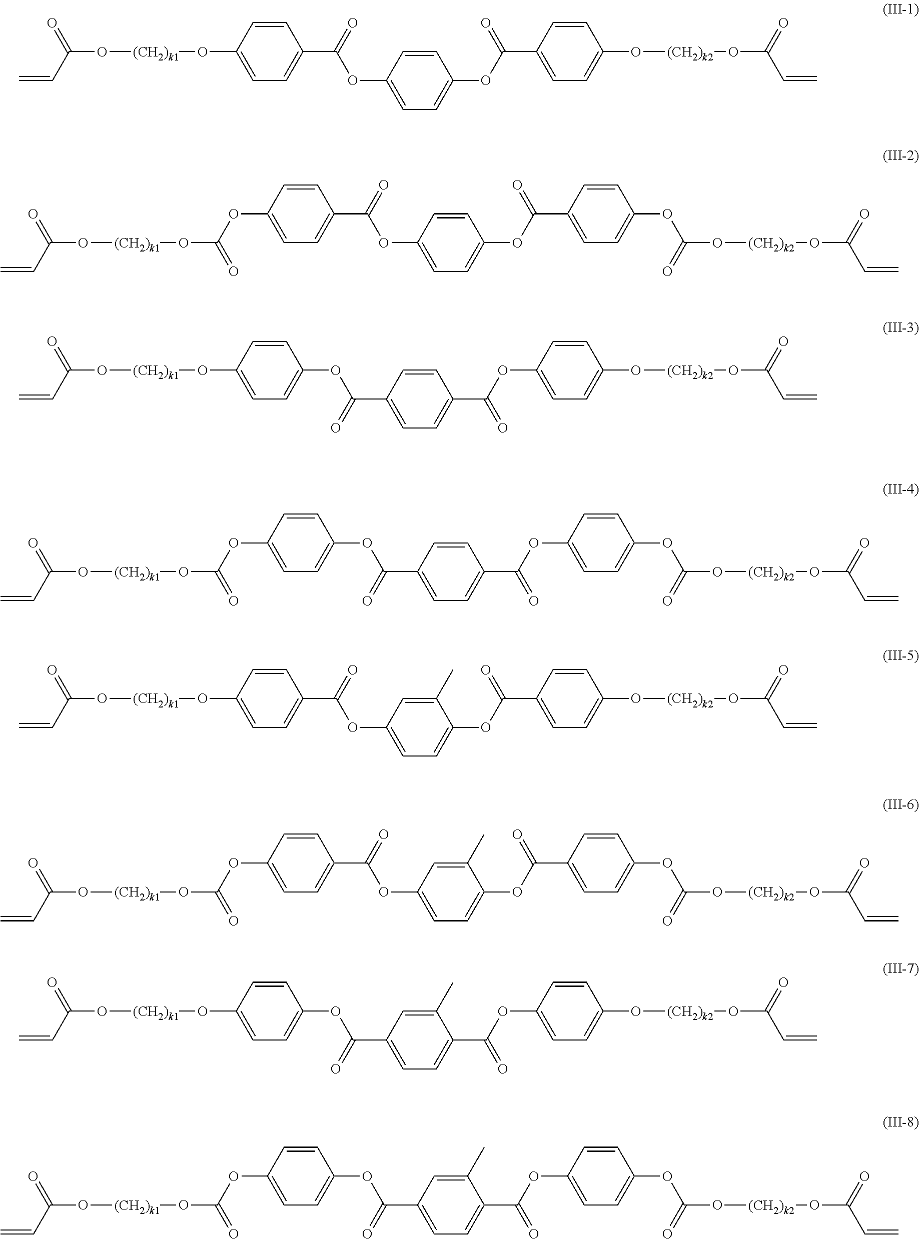

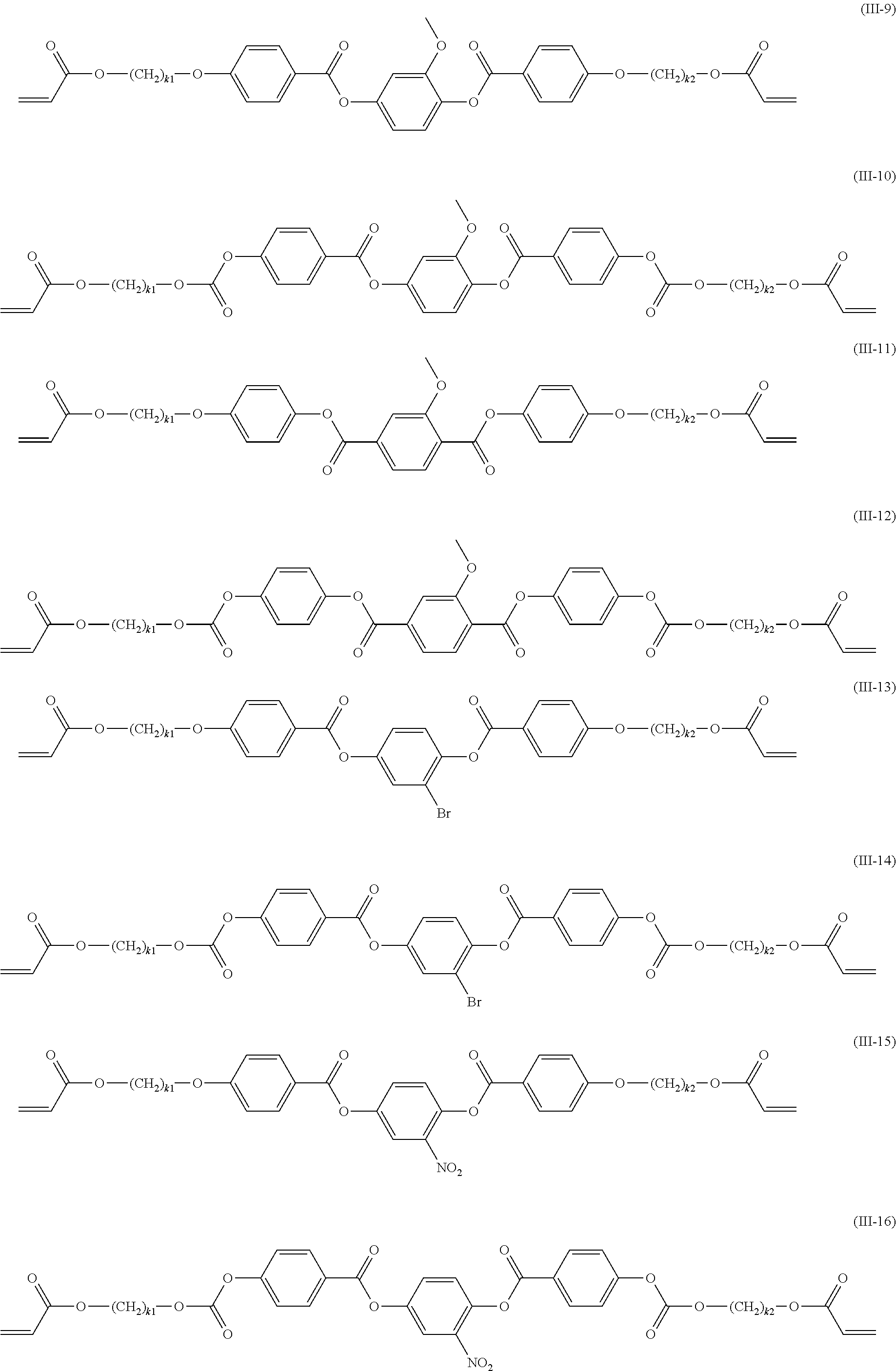

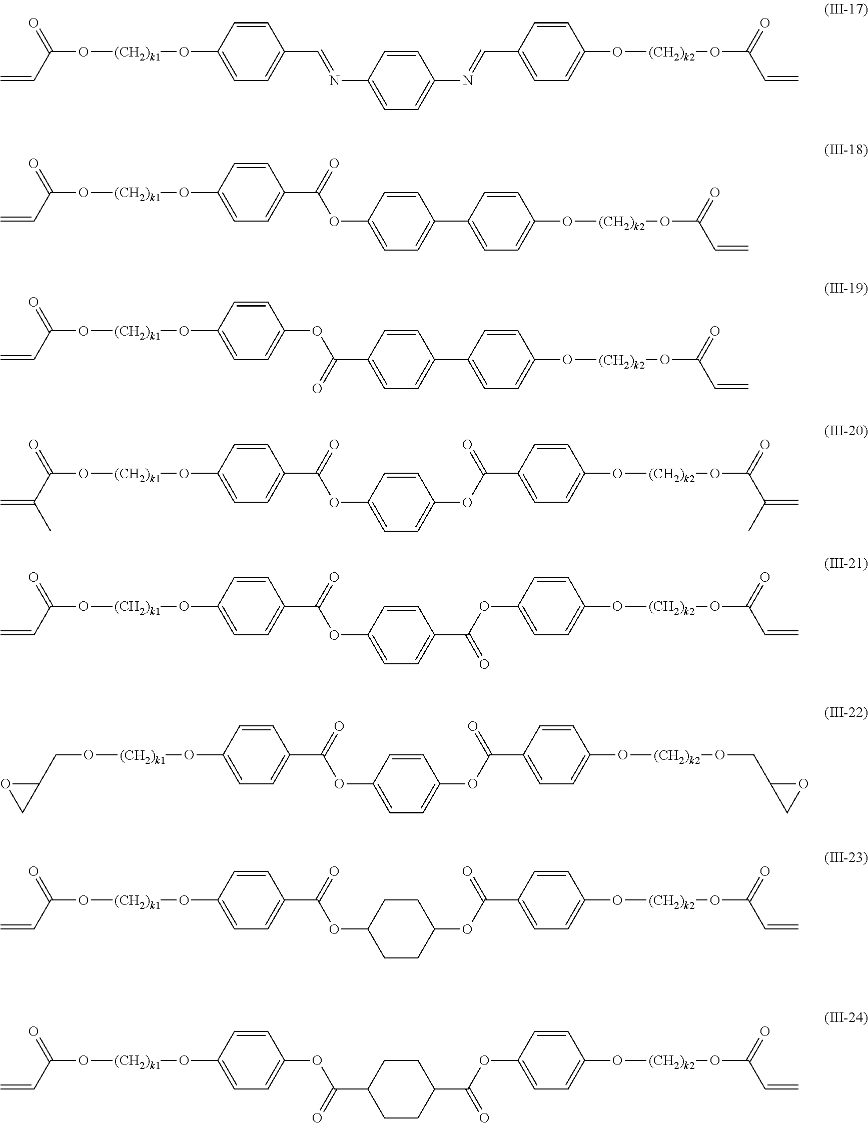

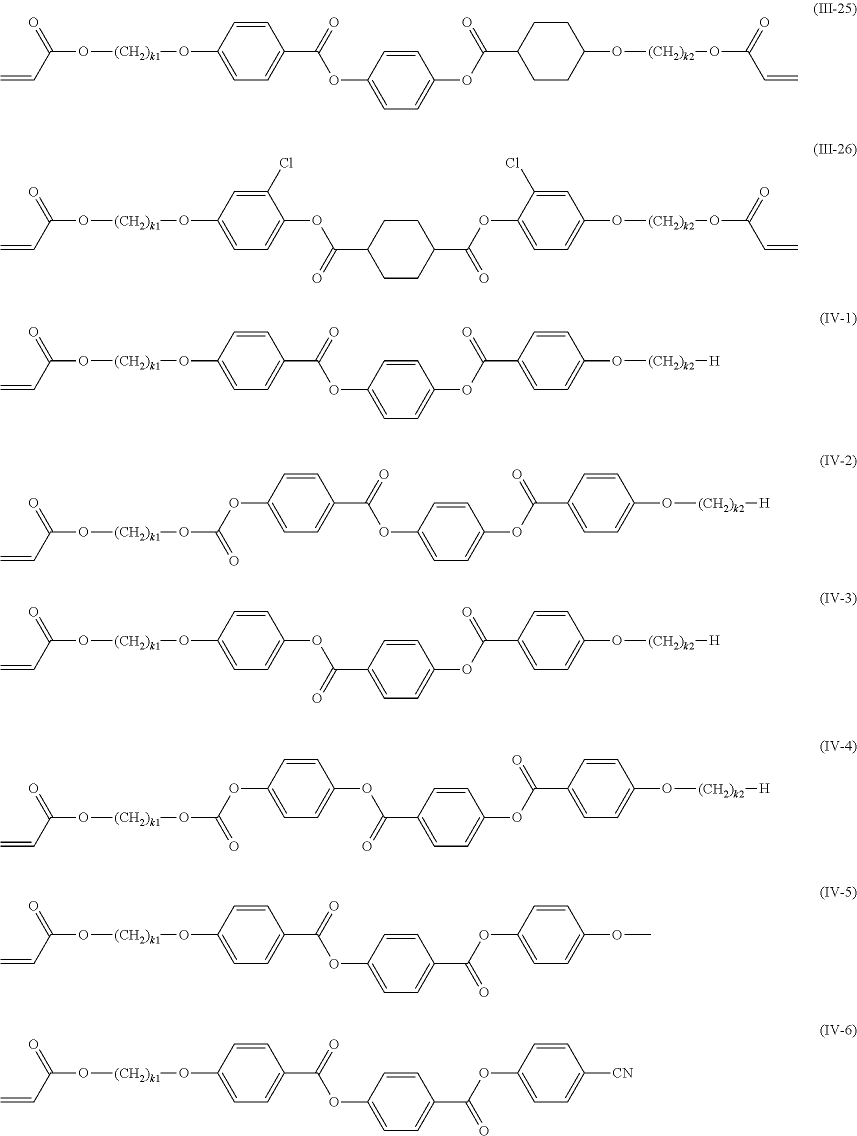

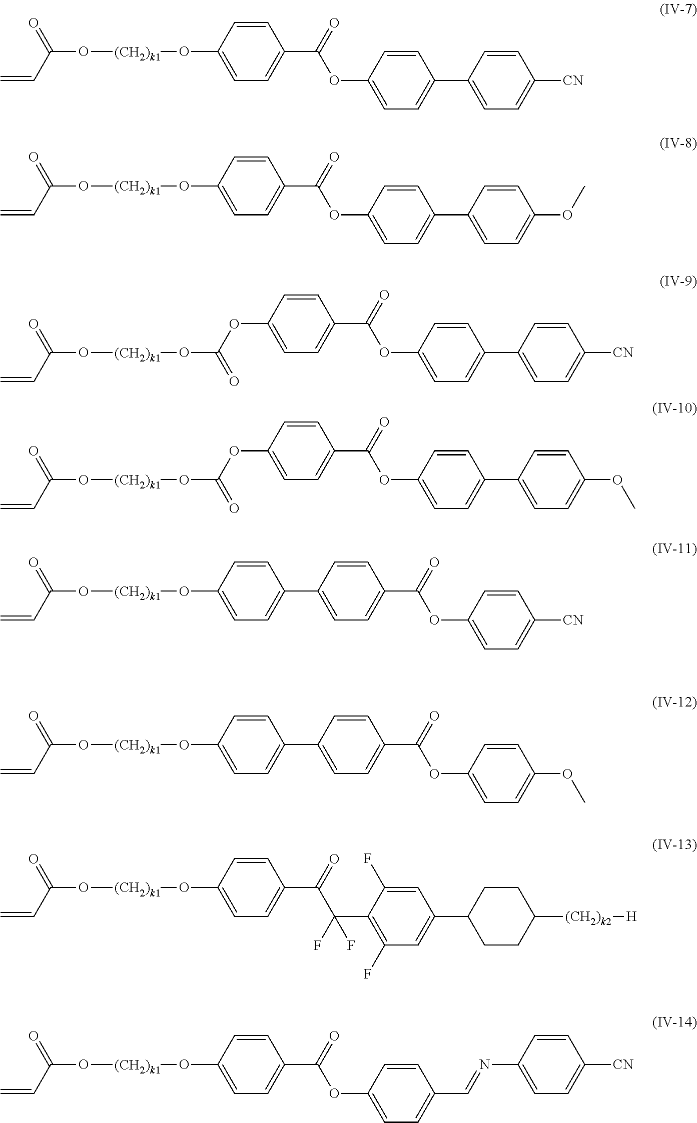

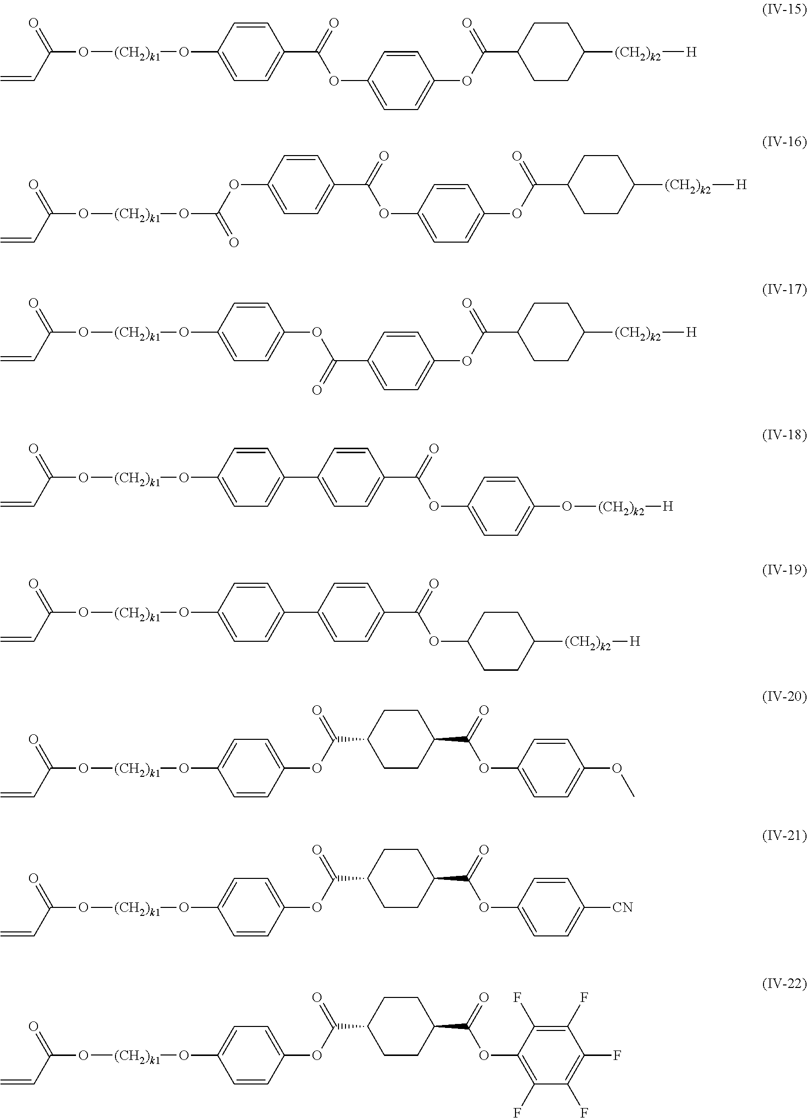

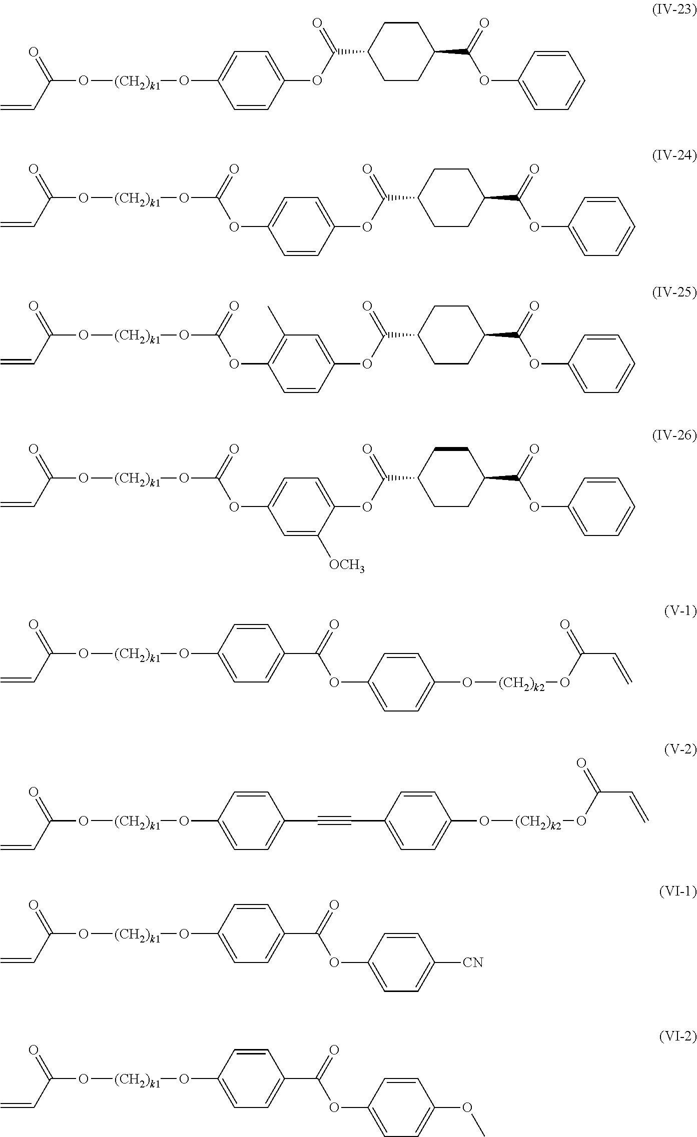

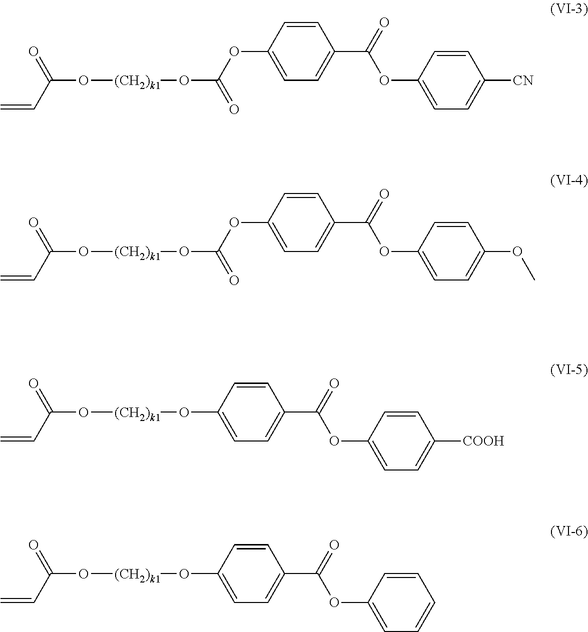

The optically-anisotropic-layer-forming composition may contain, besides the above-mentioned liquid crystal compound, a polymerization initiator, a polymerization inhibitor, a photosensitizer, a levelling agent, a chiral agent, a reactive additive, a solvent and/or some other. When the liquid crystal compound is a polymerizable liquid crystal compound, the optically-anisotropic-layer-forming composition preferably contains a polymerization initiator.

### [Polymerization Initiator]

The polymerization initiator is preferably a photopolymerization initiator. The photopolymerization initiator is preferably a photopolymerization initiator that generates radicals by irradiation with light.

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts and sulfonium salts. Specific examples thereof include products Irgacure (registered trademark) 907, 184, 651, 819, 250 and 369 (all the products are manufactured by Ciba Japan K.K.); Seikuol (registered trademark) BZ, Z, BEE (all the products are manufactured by Seiko Chemical Co. , Ltd.); Kayacure (registered trademark) BP100 (manufactured by Nippon Kayaku Co., Ltd.); UVI-6992 (manufactured by the Dow Chemical Company); Adeka Optomer (registered trademark) SP-152, and SP-170 (all the products are manufactured by Adeka Corporation); TAZ-A and TAZ-PP (all the products are manufactured by Nihon Siber Keener K.K.), and TAZ-104 (manufactured by Sanwa Chemical Co., Ltd.). Of these examples, preferred are α-acetophenone compounds. Examples of the α-acetophenone compounds include

2-methyl-2-morpbolino-1-(4-methylsulfanylphenyl)propane-1-one,

2-dimethylamino-1-(4-morpholinophenyl)-2-benzylbutane-1-one, and

2-dimethylamino-1-(4-morpholinophenyl)-2-(4-methylphenylmethyl)butane-1-one. Preferred are

2-methyl-2-morpholino-1-(4-methylsulfanylphenyl)propane-1-one, and

2-dimethylamino-1-(4-morpholinophenyl)-2-benzylbutane-1-one. Commercially available product examples of the α-acetophenone compounds include products Irgacure (registered trademark) 369, 379EG, and 907 (all the product are manufactured by BASF Japan Ltd.), and Seikuol (registered trademark) BEE (manufactured by Seiko Chemical Co., Ltd.).

The amount of the polymerization initiator is usually from 0.1 to 30 parts by mass, preferably from 0.5 to 10 parts by mass for 100 parts by mass of the liquid crystal compound. When the amount is in the range, the liquid crystal orientation of the liquid crystal compound is not easily disturbed, or the polymerizable liquid crystal compound can be polymerized without disturbing the liquid crystal orientation of this compound.

### [Polymerization Inhibitor]

Examples of the polymerization inhibitor include hydroquinone and hydroquinone analogues each having, as a substituent, an alkyl ether or the like; catechol compounds each having, as a substituent, an alkyl ether or the like, such as butylcatechol; radical capturing agents such as pyrogallol compounds, and 2,2,6,6-tetramethyl-1-piperidinyloxy radicals; thiophenol compounds; β-naphthylamine compounds; and β-naphthol compounds.

The content of the polymerization inhibitor in the composition is usually from 0.1 to 30 parts by mass, preferably from 0.5 to 10 parts by mass for 100 parts by mass of the liquid crystal compound. When the content is in the range, the liquid crystal orientation of the liquid crystal compound is not easily disturbed, or the polymerizable liquid crystal compound can be polymerized without disturbing the liquid crystal orientation of this compound.

### [Photosensitizer]

Examples of the photosensitizer include xanthone, and xanthone analogues such as thioxanthone; anthracene, and anthracene analogues such as anthracene having a substituent such as an alkylether group; phenothiamine; and rubrene.

The use of the photosensitizer makes it possible to enhance the sensitivity of the photopolymerization initiator. The content of the photosensitizer in the composition is usually from 0.1 to 30 parts by mass, preferably from 0.5 to 10 parts by mass for 100 parts by mass of the liquid crystal compound.

### [Levelling Agent]

Examples of the levelling agent include organic modified silicone oil based and polyacrylate based levelling agents, and perfluoroalkyl-containing levelling agents. Specific examples thereof include products DC3PA, SH7PA, DC11PA, SH28PA, SH29PA, SH30PA, ST80PA, ST86PA, SH8400, SH8700, and FZ2123 (all the products are manufactured by Dow Corning Toray Co. t Ltd.); KP321, KP323, KP324, KP326, KP340, KP341, X22-161A, and KF6001 (all the products are manufactured by Shin-Etsu Chemical Co., Ltd.); TSF400, TSF401, TSF410, TSF4300, TSF4440, TSF4445, TSF-4446, TSF4452, and TSF4460 (all the products are manufactured by Momentive Material Performance Materials Japan LLC); Fluorinert (registered trademark) FC-72, FC-40, FC-43, and FC-3283 (all the products are manufactured by Sumitomo 3M Limited); Megafac (registered trademark) R-08, R-30, R-90, F-410, F-411, F-443, F-445, F-470, F-477, F-479, F-482, and F-483 (all the products are manufactured by DIC Corporation); Eftop (trade name) EF301, EF303, EF351, and EF352 (all the products are manufactured by Mitsubishi Material Electronic Chemicals Co., Ltd.); Surflon (registered trademark) S-381, S-382, S-333, S-393, SC-101, SC-105, KH-40, and SA-100 (all the products are manufactured by AGC Seimi Chemical Co., Ltd. ); E1830 and E5844 ((trade names) manufactured by Daikin Fine Chemical Laboratory, Ltd.); and BM-1000, BM-1100, BYK-352, BYK-353, and BYK-361N ((tradenames) manufactured by a company, BM Chemie GmbH). Such levelling agents may be used in any combination of two or more thereof.

The levelling agent makes it possible to yield a smoother optically anisotropic film, and to control the fluidity of the optically-anisotropic-layer-forming composition or adjust the crosslinkage density of the optically anisotropic film in the production process of the optically anisotropic film. The content of the levelling agent in the composition is usually from 0.1 to 30 parts by mass, preferably from 0.1 to 10 parts by mass for 100 parts by mass of the polymerizable liquid crystal compound.

### [Chiral Agent]

The chiral agent may be a known chiral agent (for example, agents described in “Liquid Crystal Device Handbook”, Chapter 3, 4-3, Chiral Agents for TN and STN, p. 199, edited by Japan Society for the Promotion of Science, 142 Committee, 1989).

The chiral agent generally contains an asymmetric carbon atom. The chiral agent may be an axially asymmetric compound or planarly asymmetric compound, which contains no asymmetric carbon atom. Examples of the axially asymmetric compound or planarly asymmetric compound include binaphthyl, helicene, paracyclophane, and derivatives of these compounds.

Specific examples of the chiral agent include compounds as described in JP-A-2007-269639, JP-A-2007-269640, JP-A-2007-176870, JP-A-2003-137887, JP-A-2000-515496, JP-A-2007-169178, and JP-A-09-506088. The chiral agent is preferably a product Paliocolor (registered trademark) LC756 manufactured by the company BASF Japan Ltd.

The content of the chiral agent in the composition is usually from 0.1 to 30 parts by mass, preferably from 1.0 to 25 parts by mass for 100 parts by mass of the liquid crystal compound. When the content is in the range, the liquid crystal orientation of the liquid crystal compound is not easily disturbed, or the polymerizable liquid crystal compound can be polymerized without disturbing the liquid crystal orientation of this compound.

### [Reactive Additive]

The reactive additive is preferably a compound having in the molecule thereof a carbon-carbon unsaturated bond and an active hydrogen reactive group. The wording “active hydrogen reactive group” as used herein means a group reactive with an active hydrogen-containing group, such as a carboxyl group (—COOH), hydroxyl group (—OH) or amino group (—NH₂). Typical examples thereof include glycidyl, oxazoline, carbodiimide, aziridine, imide, isocyanato, thioisocyanato, and maleic anhydride groups.

It is preferred that the reactive additive has at least two active hydrogen reactive groups. In this case, the active hydrogen reactive groups may be the same or different.

The carbon-carbon unsaturated bond that the reactive additive has may be a carbon-carbon double bond, a carbon-carbon triple bond, or a combination of the two, and is preferably a carbon-carbon double bond. It is particularly preferred that the reactive additive contains, as its carbon-carbon unsaturated bond(s), a vinyl group and/or a (meth)acrylic group. Furthermore, the reactive additive preferably has, as its active hydrogen reactive group(s), at least one selected from the group consisting of epoxy, glycidyl and isocyanato groups, and in particular preferably has an acrylic group and an isocyanato group.

Specific examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline, and isopropenyl oxazoline; and oligomers each made from a compound having a (meth)acrylic group and an isocyanato group, such as isocyanatomethyl acrylate, isocyanatomethyl methacrylate, 2-isocyanatoethyl acrylate, and 2-isocyanatoethyl methacrylate. Other examples thereof include compounds each having a vinyl group or vinylene group, and an acid anhydride, such as methacrylic anhydride, acrylic anhydride, maleic anhydride, and vinylmaleic anhydride. Of these examples, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the oligomers.

More preferred examples of the reactive additive having, as its active hydrogen reactive group, an isocyanato group are specifically compounds each represented by the following formula (Y):

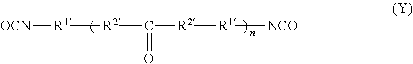

wherein n represents an integer of 1 to 10, R¹′s each represent a bivalent aliphatic or alicyclic hydrocarbon group having 2 to 20 carbon atoms, or a bivalent aromatic hydrocarbon group having 5 to 20 carbon atoms; and one of two R²′ in each of the recurring units is a group represented by —NH— and the other is a group represented by >N—C(═O)—R³′ wherein R³′ represents a hydroxyl group, or a group having a carbon-carbon unsaturated bond.

At least one of R³′ s in the formula (Y) is a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”):

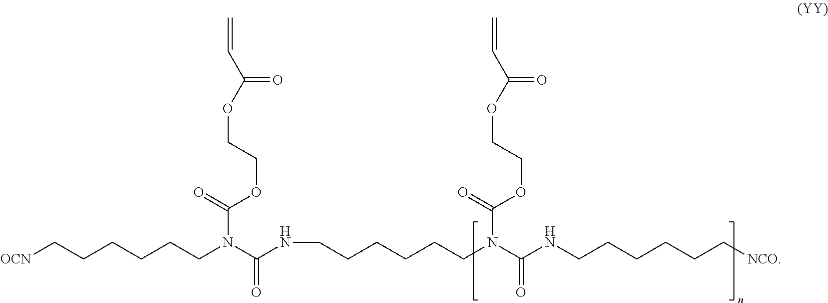

As the compound (YY), a commercially available product is usable as it is, or in the state of being purified if necessary. An example of the commercially available product is a product Laromer (registered trademark) LR-9000 (manufactured by the company BASF).

The content of the reactive additive in the composition is usually from 0.1 to 30 parts by mass, preferably from 0.1 to 5 parts by mass for 100 parts by mass of the liquid crystal compound.

### [Solvent]

The optically-anisotropic-layer-forming composition preferably contains a solvent, in particular, an organic solvent to make the operability for optically-anisotropic-film production good. The organic solvent is preferably an organic solvent in which the polymerizable liquid crystal compound, and other constituent components for the optically-anisotropic-layer-forming composition are soluble, more preferably a solvent which is inactive to the polymerization reaction of the polymerizable liquid crystal compound, the solvent in which the polymerizable liquid crystal compound and other constituent components for the optically-anisotropic-layer-forming composition are soluble. Specific examples thereof include alcohol solvents such as methanol, ethanol, ethylene glycol, isopropyl alcohol, propyleneglycol, methylcellosolve, butylcellosolve, propylene glycol monomethyl ether, and phenol; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane and heptane; non-chlorinated aromatic hydrocarbon solvents such as toluene, and xylene; nitrite solvents such as acetonitrile; ether solvents such as tetrahydrofuran, and dimethoxyethane; and chlorinated hydrocarbon solvents such as chloroform, and chlorobenzene. Such solvents maybe used in any combination of two or more thereof. Of these examples, preferred are alcohol solvents, ester solvents, ketone solvents, non-chlorinated aliphatic hydrocarbon solvents and non-chlorinated aromatic hydrocarbon solvents.

The content of the solvent in the composition is preferably from 10 to 10000 parts by mass, more preferably from 100 to 5000 parts by mass for 100 parts by mass of any solid therein. The concentration of the solid in the optically-anisotropic-layer-forming composition is preferably from 2 to 50% by mass, more preferably from 5 to 50% by mass of the composition. The “solid” means the total of the components obtained by removing the solvent from the optically-anisotropic-layer-forming composition.

An optically anisotropic film is formed by applying the optically-anisotropic-layer-forming composition to a surface of the oriented film of the oriented-film-attached resin substrate of the present invention, or attaining the same application and then drying the resultant. When the optically anisotropic film shows a liquid crystal phase such as a nematic phase, the film has birefringence based on mono-domain orientation.

The thickness of the optically anisotropic film is appropriately adjustable in accordance with the usage thereof, and is preferably from 0.1 to 10 μm, more preferably from 0.2 to 5 μm in order to make this film small in photoelasticity.

Examples of the method for the application include extrusion coating, direct gravure coating, reverse gravure coating, CAP coating, slit coating, and die coating methods; and a method of attaining the application, using a coater such as a dip coater, a bar coater, or a spin coater. Preferred are CAP coating, inkjet coating, dip coating, slit coating, die coating, and bar-coater-used coating methods since these methods make it possible to attain the application continuously in a roll-to-roll manner. When a roll-to-roll manner is employed, it is possible to apply the oriented-film-forming composition onto the resin substrate to form an oriented film, and continuously form an optically anisotropic film onto the outer surface of the resultant oriented film.

Examples of the method for the drying include the same methods as used for drying the oriented-film-forming composition when the oriented-film-attached resin substrate is produced. Of these examples, preferred are natural drying and heat drying. The drying temperature is preferably from 0 to 250° C., more preferably from 50 to 220° C., even more preferably from 80 to 170° C. The drying period is preferably from 10 seconds to 60 minutes, more preferably from 30 seconds to 30 minutes.

When the optically anisotropic film contains a polymerizable liquid crystal compound, this polymerizable liquid crystal compound may be polymerized to harden the film. The optically anisotropic film obtained by polymerizing the polymerizable liquid crystal compound is not easily affected by a change in the birefringence thereof on the basis of heat since the liquid crystal orientation of the polymerizable liquid crystal compound is fixed.

The method for polymerizing the polymerizable liquid crystal compound is preferably photopolymerization. The photopolymerization makes it possible to polymerize the compound at a low temperature. Thus, the choice of a resin substrate to be used is widened from the viewpoint of heat resistance. Reaction for the photopolymerization is usually conducted by irradiation with visible rays, ultraviolet rays or a laser, and is preferably conducted by irradiation with ultraviolet rays.

When the applied optically-anisotropic-layer-forming composition contains a solvent, the irradiation with the light is performed preferably after the solvent is removed by drying. The drying maybe performed simultaneously with the irradiation with the light. Preferably, before the irradiation with the light is performed, almost all of the solvent should be removed.

Thus, a laminated body is obtained which has the oriented-film-attached resin substrate, and the optically anisotropic film to arrange the resin substrate and the oriented film of the substrate, and the optically anisotropic film in this order. The laminated body of the present invention is excellent in transparency in the range of visible ray wavelengths, and is useful as a member for various display devices.

The chromaticity b* of the laminated body is usually 0.5 or less, preferably 0.4 or less, more preferably 0.35 or less.

The laminated body in which its optically anisotropic film is a retardation film is particularly useful as a laminated body for converting, into circularly polarized light or elliptically polarized light, polarized light considered to be linearly polarized light when the polarized light is checked from any oblique angle at the light-radiating-out side of the body; for converting polarized light considered to be circularly or elliptically polarized light into linearly polarized light; or for changing the polarization direction of linearly polarized light.

Laminated bodies in each of which its optically anisotropic film is a retardation film may be laminated onto each other, or the laminated body in which its optically anisotropic film is a retardation film may be combined with a different film. The combination with the different film is usable as a viewing angle compensating film, a viewing angle enlarging film, an antireflective film, a polarizing plate, a circularly polarizing plate, an elliptically polarizing plate, or a brightness enhancement film.

The laminated body can be changed in optical property in accordance with the orientation state of the liquid crystal compound. The laminated body is usable as a retardation plate for a liquid crystal display device that may be in various modes such as a vertical alignment (VA) mode, an in-plane switching (TPS) mode, an optically compensated bend (OCB) mode, a twisted nematic (TN) mode, and a super twisted nematic (STN) mode. The laminated body is preferably usable particularly for an IPS mode liquid crystal display device.

When the refractive index of the laminated body in the in-plane slow axis direction thereof is represented by nₓ, that in the direction orthogonal to the in-plane slow axis (i.e., the fast axis direction) by n_{y}, and that in the thickness direction thereof by n_{z}, the laminated body can be classified as follows:
a positive A plate in which nₓ>n_{y}≅n_{z},
a negative C plate in which nₓ≅n_{y}>n_{z},
a positive C plate in which nₓ≅n_{y}<n_{z}, and
a positive O plate and a negative O plate in which nₓ≠n_{y}≠n_{z}.

It is advisable to select the retardation value of the laminated body appropriately from the range of 30 to 300 nm in accordance with a display device in which the laminated body is used.

When the laminated body is used as a positive C plate, it is advisable to adjust the front retardation value Re (549) into the range of 0 to 10 nm, preferably into that of 0 to 5 nm, and adjust the thickness direction retardation value Rₜₕ into the range of −10 to −300 nm, preferably into that of −20 to −200 nm. It is particularly preferred to adjust these values in accordance with properties of the liquid crystal cell.

The thickness direction retardation value Rₜₕ, which means the refractive index anisotropy of the laminated body in the thickness direction, can be calculated from the retardation value R₄₀ measured in the state of inclining the in-plane fast axis of the body at 40 degrees to be rendered an inclined axis, and the in-plane retardation value R₀. Specifically, the thickness direction retardation value Rₜₕ can be calculated by: using plural values (i.e., the in-plane retardation value R₀, the retardation value R₄₀, which is measured in the state of inclining the fast axis at 40 degrees to be rendered an inclined axis, the retardation film thickness d, and the average refractive index n₀ of the retardation film) to calculate the refractive indexes nₓ, n_{y} and n_{z} through equations (9) to (11) described below; and then substituting these refractive indexes for an equation (8) described below.

Rₜₕ=[(nₓ+n_{y})/2−n_{z}]×d (8),

R₀=(nₓ−n_{y})×d (9),

R₄₀=(nₓ−n_{y}′)×d/cos (φ) (10), and

(nₓ+n_{y}+n_{z})/3=n₀ (11)

wherein φ=sin⁻¹ [sin (40°)/n₀], and

n_{y}′=n_{y}×n_{z}/[n_{y}²×sin²(φ)+n_{z}²×cos²(φ)]^{1/2}.

In order to laminate an additional layer onto the optically anisotropic film of the laminated body, a photocurable resin may be applied onto this film (the present step is called a subsequent step in the present invention). The photocurable resin is preferably an ultraviolet curable resin. In order to attain the photocuring in the subsequent step, light is radiated onto the laminated body from the substrate side thereof. In such a light radiation in the prior art, the laminated body may turn yellow or the orientation of its polymerizable liquid crystal compound may be disturbed when the laminated body is low in endurance. The laminated body yielded by use of the oriented-film-forming composition of the present invention is not changed even by the light radiation in the subsequent step, to give an advantage of showing a high endurance.

The laminated body of the present invention is useful also as a member constituting a polarizing plate.

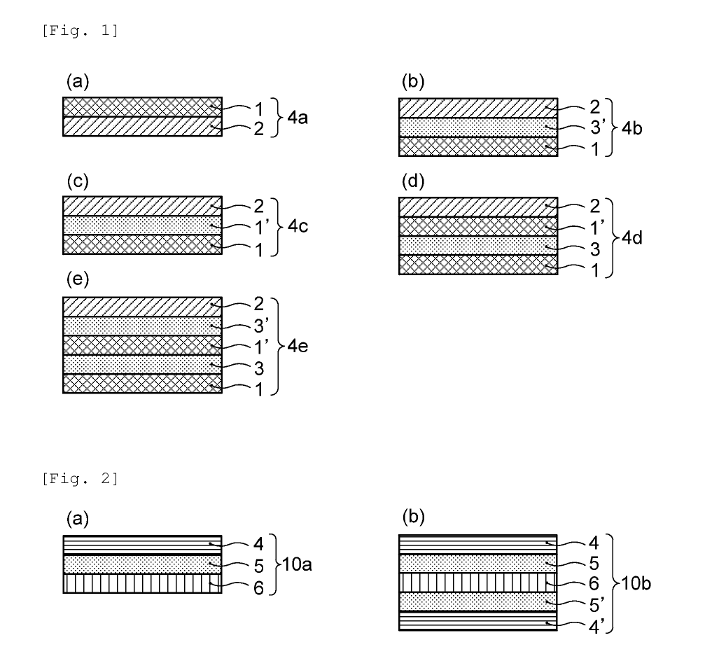

Specific examples of the polarizing plate include respective polarizing plates 4a to 4e illustrated in FIGS. 1A to 1E. The polarizing plate 4a illustrated in FIG. 1A is a polarizing plate in which a retardation film 1 and a polarization film 2 are laminated directly onto each other. The polarizing plate 4b illustrated in FIG. 1B is a polarizing plate in which a retardation film 1 and a polarization film 2 are bonded onto each other through an adhesive layer 3′. The polarizing plate 4c illustrated in FIG. 1C is a polarizing plate in which retardation films 1 and 1′ are laminated onto each other and further a polarization film 2 is laminated onto the retardation film 1′. The polarizing plate 4d illustrated in FIG. 1D is a polarizing plate in which retardation films 1 and 1′ are bonded onto each other through an adhesive layer 3, and further a polarization film 2 is laminated onto the retardation film 1′. The polarizing plate 4e illustrated in FIG. 1E is a polarizing plate in which retardation films 1 and 1′ are bonded onto each other through an adhesive layer 3, and further the retardation film 1′ and a polarization film 2 are bonded onto each other through an adhesive layer 3′. The wording “adhesive” is a generic name of any adhesive and/or any binder.

The laminated body of the present invention in which its optically anisotropic film is a retardation film is usable as each of the retardation films 1 and 1′. The laminated body of the present invention in which its optically anisotropic film is a polarization film is usable as each of the polarization films 2.

It is sufficient for each of the polarization films 2 to be a film having a polarizing function. Besides the laminated body of the present invention, the following is usable therefor: a film obtained by causing iodine or a dichroic dye to be adsorbed to a polyvinyl alcohol based film, and then drawing the resultant film; or a film obtained by drawing a polyvinyl alcohol based film, and then causing iodine or a dichroic dye to be adsorbed to the drawn film.

The polarization film 2 maybe protected with a protective film if necessary. Examples of the protective film include polyolefin films, examples of the polyolefin including polyethylene, polypropylene and norbornene polymers; and polyethylene terephthalate, polymethacrylate, polyacrylate, cellulose ester, polyethylene naphthalate, polycarbonate, polysulfone, polyethersulfone, polyetherketone, polyphenylenesulfide, and polypnenyleneoxide films.

The adhesive that forms the adhesive layers 3 and 3′ is preferably an adhesive high in transparency and excellent in heat resistance. Examples of the adhesive include acrylic based, epoxy based and methane based adhesives.

The display device of the present invention has the laminated body of the invention. Examples of the display device include a liquid crystal display device having a liquid crystal panel in which the laminated body of the invention and a liquid crystal panel are bonded to each other; and an organic electroluminescence (also abbreviated to EL hereinafter) display device having an organic EL panel in which the laminated body of the invention and a luminous layer are bonded to each other. Hereinafter, a description will foe made about liquid crystal display devices as embodiments of the display device of the invention, which has the laminated body of the invention.

In embodiments, the liquid crystal display devices are shown as liquid crystal display devices 10a and 10b illustrated in FIGS. 2A and 2B, respectively. In the liquid crystal display device 10a illustrated in FIG. 2A, a polarizing plate 4 of the present invention and a liquid crystal panel 6 are bonded through an adhesive layer 5. In the liquid crystal display device 10b illustrated in FIG. 2B, a polarizing plate 4 of the present invention is bonded to one of the two main surfaces of a liquid crystal panel 6 through an adhesive layer 5 while a polarizing plate 4′ of the invention is bonded to the other main surface of the liquid crystal panel 6 through an adhesive layer 5′. Electrodes not illustrated are used in these liquid crystal display devices to apply a voltage to their liquid crystal panel to change the orientation of molecules of their liquid crystal. In this way, a monochrome display can be realized.

### Examples

Hereinafter, the present invention will be more specifically described by way of working examples thereof. In the examples, the symbol “%” and the word “part(s)” denote “% by mass” and “part(s) by mass”, respectively, unless otherwise specified.

### [Oriented-Film-Forming Compositions]

An antioxidant was added to a solution in which N-methyl-2-pyrrolidone and butylcellosolve were added to an orienting polymer to yield each of oriented-film-forming compositions (1) to (3) and (H1).

Table 1 shows these components in its top row. About each of the compositions, the proportion of the amount of each of the components to the total amount of the composition is represented by a numerical value in the corresponding row in Table 1. The proportion of any solid in the orienting polymer is converted from the polymer concentration described in a delivered specification of the polymer.

TABLE 1

| | Orienting | N-methyl-2- | | |
|---|---|---|---|---|
| | polymer | pyrrolidone | Butylcellosolve | Antioxidant |
| (1) | 0.59% | 79.52% | 19.88% | BHT: 0.01% |
| (2) | 0.59% | 79.52% | 19.88% | GM: 0.01% |
| (3) | 0.59% | 79.52% | 19.88% | GS-F: 0.01% |
| (H1) | 0.60% | 79.52% | 19.88% | — |

Orienting polymer: Sunever (registered trademark) SE-610 (manufactured by Nissan Chemical Industries, Ltd.)

Antioxidants:
BHT: 2,6-bis)1,1-dimethylethyl)-4-methylphenol (manufactured by Tokyo Chemical Industry Co., Ltd.)
GM: SUMILIZER (registered trademark) GM (manufactured by Sumitomo Chemical Co., Ltd.)
GS-F: SUMILIZER (registered trademark) GS-F (manufactured by the same).

### [Optically-Anisotropic-Layer-Forming Composition]

Individual components shown in Table 2 were mixed with each other, and the resultant solution was stirred at 80° C. for 1 hour. The solution was then cooled to room temperature to yield an optically-anisotropic-layer-forming composition (1).

TABLE 2

| | Liquid | | | | |
|---|---|---|---|---|---|
| | crystal | Photopolymerization | Leveling | Reactive | |
| | compound | initiator | agent | additive | Solvent |
| (1) | 19.2% | 0.5% | 0.1% | 1.1% | 79.1% |

Unit in the table: % (the proportion of each of the components in the optically-anisotropic-layer-forming composition)

Liquid crystal compound: a liquid crystal compound represented by the following formula (manufactured by the company BASF):

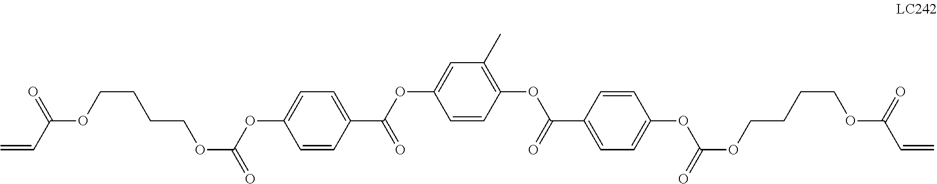 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

Photopolymerization initiator: Irgacure (registered trademark) 369 ((trade name) manufactured by BASF Japan Ltd.)

Levelling agent: BYK-361N ((trade name) manufactured by BYK-Chemie Japan K.K.)

Reactive additive: Laromer (registered trademark) LR-9000 (manufactured by BASF Japan Ltd.)

Solvent: propylene glycol monomethyl ether acetate

### Example 1

A corona treatment machine (AGF-B10, manufactured by Kasuga Electric Works Ltd.) was used to treat a surface of a cycloolefin polymer film (ZF-14, manufactured by Zeon Corporation) one time at a power of 0.3 kW and a treatment rate of 3 m/minute.

The oriented-film-forming composition (1) was applied onto the corona-treated surface, and the resultant was dried to produce an oriented-film-attached resin substrate with an oriented film having a thickness of 47 nm. A bar coater was used to apply the optically-anisotropic-layer-forming composition (1) onto the outer surface of the oriented film of the oriented-film-attached resin substrate, and then the workpiece was heated to 90° C. to be dried, and then cooled to room temperature. Thereafter, an instrument Unicure (VB-15201BY-A, manufactured by Ushio Inc.) was used to radiate ultraviolet ray (wavelength: 365 nm; illuminance: 40 mW/cm²) to the workpiece for 30 seconds to yield a laminated body (1) in which the resin substrate, the oriented film and an optically anisotropic film were laminated onto each other in this order.

### Examples 2 and 3, and Comparative Example 1

Laminated bodies (2), (3) and (H1) were produced in the same way as in Example 1 except that the oriented-film-forming composition (1) was changed to the oriented-film-forming compositions (2), (3) and (H1), respectively.

### [Heating Stability Check]

About each of the oriented-film-forming compositions (1) to (3), and (H1), the weight-average molecular weight Mw(A) of their orienting polymer was measured. The composition was heated at 100° C. for 1 hour, and then the weight-average molecular weight Mw(B) of the orienting polymer was measured.

The measurement was made using the GPC method after the composition was diluted 10 times with tetrahydrofuran. The measuring conditions are described below. The results are shown in Table 3.

Instrument: HLC-8220 GPC (manufactured by Tosoh Corporation)
Column: TOSOH TSKgel Multipore H_{XL}-M
Column temperature: 40° C.
Solvent: tetrahydrofuran
Flow rate: 1.0 mL/min.
Detector: RI
Standard substances for calibration: TSK STANDARD POLYSTYRENE F-40, F-4, F-288, A-5000, and A-500.

### [Optical Property Measurement]

A measuring instrument (KOBRA-WR, manufactured by a company, Oji Scientific Instruments) was used to measure the respective retardation values of the laminated bodies (1) to (3) and (H1). The measurement was made while the incident angle of light, into each of the samples was varied. In this way, it was checked whether or not its liquid crystal was vertically oriented. The results are shown in Table 3.

### [Subsequent-Step-Endurance Check]

The instrument Unicure (VB-15201BY-A, manufactured by Ushio Inc.) was used to radiate ultraviolet ray (wavelength: 365 nm; illuminance: 40 mW/cm²) to each of the laminated bodies (1) to (3) and (H1) from the substrate side thereof for 25 seconds. An ultraviolet-visible-infrared spectrometer (UV-3150, manufactured by Shimadzu Corporation) was used to measure the transmittance of the resultant laminated body. From the measured transmittance, the chromaticity b* thereof in the L*a*b* (CIE) color coordinate system was calculated. In this way, the chromaticity was evaluated. The results are shown in Table 3.

TABLE 3

| | Mw(A)/ | | |
|---|---|---|---|
| | Mw(B) | Orientation | b* |
| Example 1 | 0.94 | Vertical | 0.29 |
| | | orientation | |
| Example 2 | 0.93 | Vertical | 0.32 |
| | | orientation | |
| Example 3 | 0.95 | Vertical | 0.31 |
| | | orientation | |
| Comparative | 0.83 | Vertical | 0.54 |
| Example 1 | | orientation | |

It was verified that the laminated bodies of Examples 1 to 3 had a thermal stability making re-heating thereof possible. and were further able to endure a light radiating step therefor.

According to the oriented-film-forming composition of the present invention, a laminated body can be obtained which has a substrate, an oriented film and an optically anisotropic film and is excellent in heat resistance and light resistance.

1. An oriented-film-forming composition, comprising an oriented-film-forming material and an antioxidant.

2. The composition according to claim 1, wherein the antioxidant is a phenolic antioxidant.

3. The composition according to claim 1, wherein the oriented-film-forming material comprises at least one selected from the group consisting of polyimides, polyamides and polyamic acids.

4. The composition according to claim 1, which satisfies Mw(A)/Mw(B)>0.85 wherein Mw(B) represents the weight-average molecular weight of the oriented-film-forming material after the composition is heated at 100° C. for 1 hour, and Mw(A) represents the weight-average molecular weight of the oriented-film-forming material before the heating.

5. The composition according to claim 1, wherein the oriented-film-forming material has an orientation regulating force for causing a polymerizable liquid crystal compound to be vertically oriented.

6. An oriented-film-attached resin substrate, comprising a resin substrate, and an oriented film formed over a surface of the resin substrate and comprising the composition recited in claim 1.

7. The oriented-film-attached resin substrate according to claim 6, wherein the resin substrate comprises a polyolefin.

8. A method for producing an oriented-film-attached resin substrate, comprising: applying the composition recited in claim 1 to a resin substrate, and drying the resultant.

9. A laminated body, comprising the oriented-film-attached resin substrate recited in claim 6, and an optically anisotropic film to arrange the resin substrate and the oriented film of the substrate, and the optically anisotropic film in this three-member-described order.

10. The laminated body according to claim 9, wherein the optically anisotropic film is a retardation film.

11. The laminated body according to claim 9, which is used for an in-plane switching (IPS) liquid crystal display device.

12. A method for producing a laminated body comprising a resin substrate, an oriented film, and an optically anisotropic film in the order that the three members are described herein,
comprising: applying the composition recited in claim 1 to the resin substrate, thereby yielding an oriented-film-attached resin substrate; further applying a composition comprising a polymerizable liquid crystal compound and a photopolymerization initiator to the outer surface of the oriented film of the oriented-film-attached resin substrate; and radiating light to the resultant laminated body.

13. A polarizing plate, comprising the laminated body recited in claim 1.

14. A display device, comprising the laminated body recited in claim 1.
